(19) United States
(12) Patent Application Publication
(10) Pub. No.: US 2021/0182319 A1
(43) Pub. Date: Jun. 17, 2021

(54) MAP SEARCH INTERFACE SYSTEM FOR GIS OBJECTS HAVING NON-SPECIFIABLE LOCATION ATTRIBUTES

(71) Applicant: Malcom Imad, Campsie (AU)

(72) Inventor: Malcom Imad, Campsie (AU)

(21) Appl. No.: 16/710,587

(22) Filed: Dec. 11, 2019

(51) Int. Cl. G06F 16/29; G06F 16/9537; G06F 16/9538; G06F 16/9535; G06F 3/14; H04W 4/021

(52) U.S. Cl. CPC G06F 16/29; G06F 16/9537; H04W 4/021; G06F 16/9535; G06F 3/14; G06F 16/9538

(57) ABSTRACT

A map search interface system receives GIS object location and attribute data of a plurality of GIS objects. The system can then receive GIS object search parameters in relation to a geographic subregion within GIS data. The system determines a subset of GIS objects of the plurality of GIS objects falling within the geographic subregion according to location data thereof and the geographic subregion. The system assigns search parameter match total categories to each of the subset of GIS objects according to attribute data of the subset of GIS objects and the GIS object search parameters and generates a map search interface comprising a map rendered from the GIS data wherein the map search interface displays the geographic subregion and the search parameter match total categories of the subset of GIS objects, without displaying a specific location of each respective GIS object.

### FIELD OF THE INVENTION

This invention relates generally to search interfaces and, more particularly, to map search interface system for GIS objects having non-specifiable location attributes.

### BACKGROUND OF THE INVENTION

FIG. 1 shows a typical map search interface 100 of the prior art for searching for properties wherein the location thereof cannot be specified, such as for off-market property sale listings.

The interface 100 comprises a search interface 101 and a search parameter input field 102 into which various search parameters may be entered. The interface 101 comprises a map rendering 103 displaying properties matching the search parameters.

However, without disclosing the specific location of each matching property, the interface 100 rather typically shows the general region 104 of the search results within a degree of proximity such that the specific location of each property cannot be determined with certainty.

The present invention seeks to provide improvements to map search interfaces for searching for GIS objects wherein location attributes thereof cannot be displayed or specified which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

According to one aspect, there is provided a map search interface system comprising computer program code instructions controllers configured to: receive, in relation to user profiles of a first type, GIS object location and attribute data of a plurality of GIS objects; receive, in relation to a user profile of a second type, GIS object search parameters; at least one of receive and determine a geographic subregion within GIS data; determine a subset of GIS objects of the plurality of GIS objects falling within the geographic subregion according to location data thereof and the geographic subregion; assign search parameter match total categories to each of the subset of GIS objects according to attribute data of the subset of GIS objects and the GIS object search parameters; and generate a map search interface comprising a map rendered from the GIS data, the map search interface displaying the geographic subregion and the search parameter match total categories of the subset of GIS objects, without displaying a specific location of each respective GIS object.

The geographic subregion may be selected from subregions specified by the GIS data.

The geographic region may be displayed as a boundary demarcation overlay on the map.

At least one of receiving and determining a geographic subregion within the GIS data may comprise receiving, via the map search interface, a geographic region identifier and looking up the geographic region boundary data from the GIS data.

The map may be an interactive map and wherein at least one of receiving and determining the geographic subregion within the GIS data may comprise determining the geographic subregion in accordance with a view port of the map.

The geographic subregion may be selected as a most central geographic subregion within the viewport.

The map search interface may display each search parameter match total category as a numeric value.

The map search interface may display each search parameter match total category as at least one of a different colour and a different shade of a colour.

The map search interface may comprise a plurality of search parameter input fields and wherein the search parameter match total categories may be displayed dynamically responsive to data input via the search parameter input fields.

The system may further comprise receiving a selection of a category via the map search interface and displaying an informational interface listing of the GIS objects within the category without displaying a specific location thereof.

The system may further comprise receiving a GIS object ID of a GIS object wherein the computer program code instruction controllers may be further configured to: determine a geographic subregion according to location data of the GIS object; assign a search parameter match total category to the GIS object according to attributes of the GIS object and the GIS object search parameters; and generating a GIS object informational interface comprising a map rendered from the GIS data and displaying the geographic subregion and the search parameter match total category.

The geographic subregion may be generated as a boundary demarcation overlay on the map.

The boundary demarcation overlay may be displayed in at least one of a colour and a shade of colour according to the search parameter match total category.

The search parameter match total category may be displayed using a visual indicator wherein elements thereof may be highlighted according to the search parameter match total category.

The visual indicator may comprise a plurality of concentric layers and wherein subsets thereof may be displayed at least one of from outside in an inside out depending on the search parameter match total category.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a map search interface in accordance of the prior art;

FIG. 2 shows a map search interface system in accordance with an embodiment;

FIG. 3 shows an exemplary map search interface in accordance with an embodiment;

FIG. 4 shows a process for the generation of the map search interface of FIG. 3 in accordance with an embodiment;

FIG. 5 shows an exemplary GIS object information interface in accordance with an embodiment;

FIG. 6 illustrates a process for generating the GIS object information interface of FIG. 5 in accordance with an embodiment;

FIG. 7 illustrates a GIS object comprising location and attribute data;

FIG. 8 illustrates a user profile information interface in accordance with an embodiment; and

FIG. 9 illustrates a process for generating the interface of FIG. 8 in accordance with an embodiment.

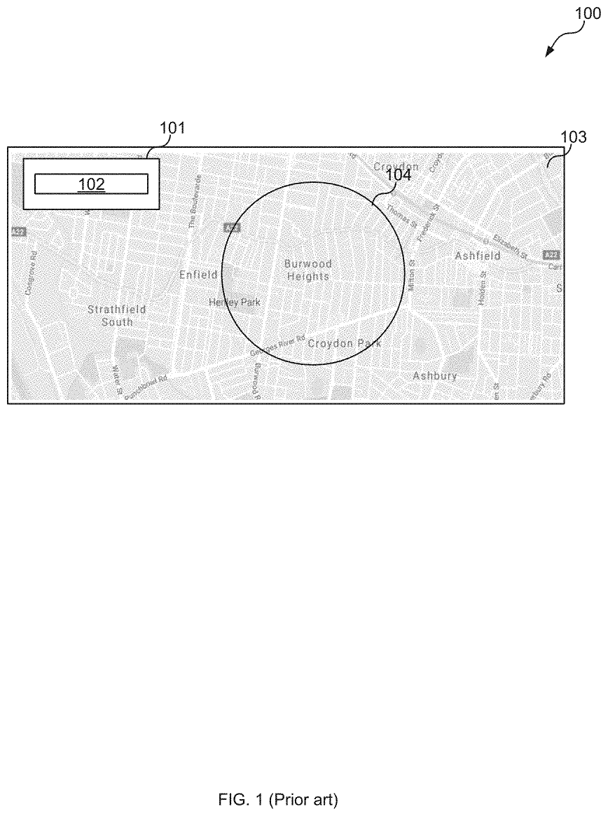

### DESCRIPTION OF EMBODIMENTS

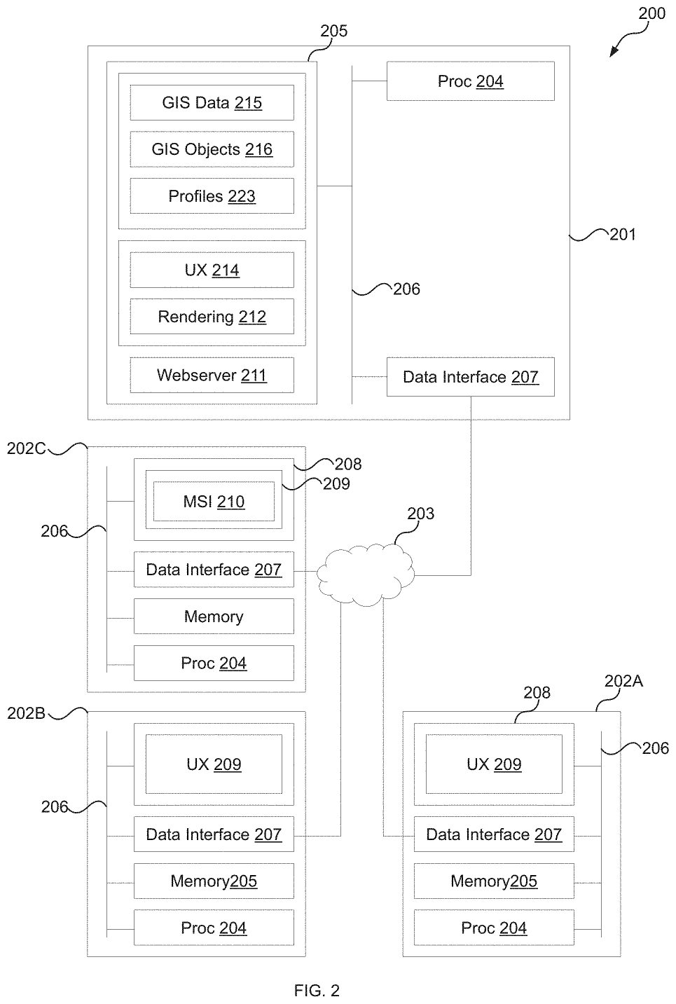

FIG. 2 shows a map search interface system 200 which may comprise a server 201 in operable communication with a plurality of client terminals 202 across a wide area network 203 such as the Internet.

Each computing device shown in FIG. 2 comprises a processor 204 for processing digital data. The processor 204 is operably coupled to a memory device 205 across a system bus 206. The memory device 205 stores digital data including computer program code instructions and associated data therefor. In use, the processor 204 fetches these computer program code instructions and the associated data from the memory device 205 for interpretation and execution in implementing the functionality provided herein.

Each computer device may comprise a data interface 207 for sending and receiving data across the wide area network 203.

Each client terminal 202 may comprise a digital display device 208 in operable communication with the respective processor 204 and system bus 206 thereof for displaying digital data including user interfaces 209. At least one of the client terminals 202 displays a map search interface 210.

In embodiments, the server 201 execute a webserver application 211 wherein at least one client terminal 202 executes a web browser application for rendering webpage resources served by the webserver 211.

The computer program code instructions may be logically divided into various computer program code instruction controllers 212 and associated data 213.

The server 201 may comprise a user interface controller 214 for controlling the user interfaces 209 and the rendering controller 212 for rendering maps, including of the map search interface 210.

The associated data 230 may comprise GIS data 215 and a plurality of GIS objects 216 used in relation to the GIS data 215.

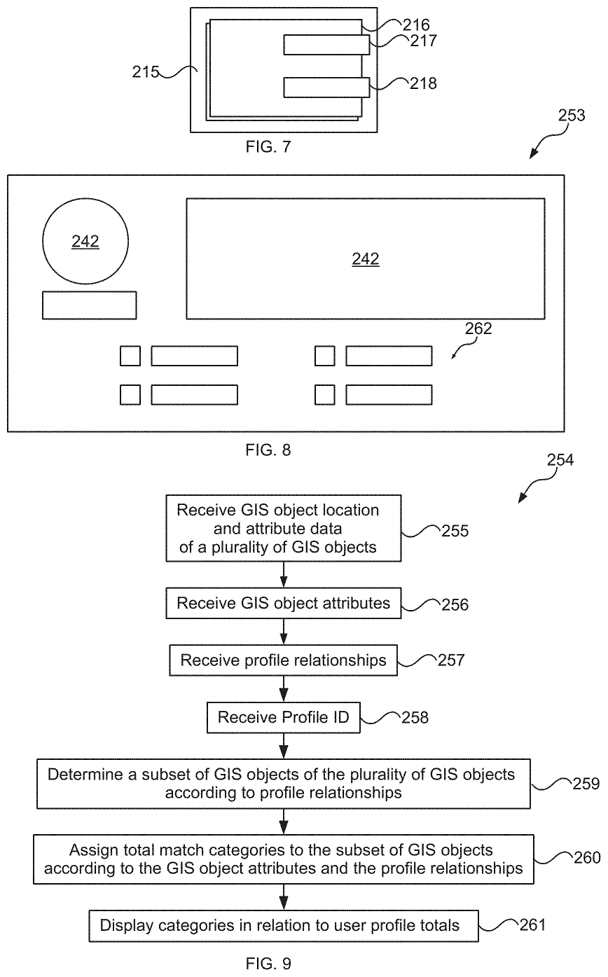

With reference to FIG. 7, there is shown a plurality of GIS objects 216 used in relation to the GIS data 215. Each GIS object 216 comprises location data 217 and other attributes 218. In relation to real estate, the attributes 218 may represent attributes including price, features (such as number of bathrooms, bedrooms, garages and the like) and proximity (such as proximity to schools, transport and the like) and other attributes.

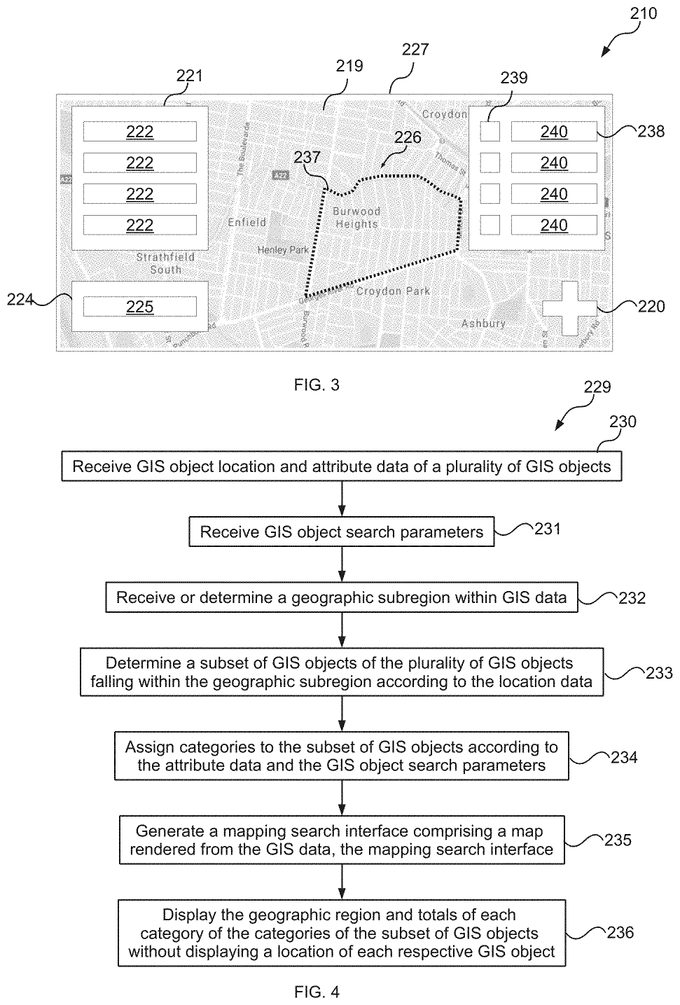

FIG. 3 shows an exemplary map search interface 210 in accordance with an embodiment.

The interface 210 comprises a map 219 which is rendered by the rendering controller 212 using the GIS data 215. As is shown, the map rendering 219 may display streets, suburb names and other features and locations. The map 219 may be interactive and may comprise navigational controls 220 for panning and zooming.

The interface 211 may comprise a search parameter interface 221 comprising a plurality of input fields 222 into which various search parameters may be input. With reference to real estate, search parameters may be input to search for real estate properties according to price, features, proximity and other search parameters.

Whereas the search parameter interface 211 is shown overlaid or adjacent the map 219 in a preferred embodiment for interactive real-time searching, in alternative embodiments, search parameters may be stored in relation to user profiles 223 which may be configured during user registration.

The interface 210 may comprise a region search interface 224 which may comprise a subregion search input field 225 wherein subregions within the map 219 may be searched.

Typically, the system 200 employs suburbs defined within the GIS data 215 as subregions. In this regard, a postcode, suburb name or the like may be input into the subregion search input field 225.

Alternatively, the system 200 may determine the plurality or the main subregion within the view port 227 of the map 219 as the user navigates using the navigational controls 220. For example, as the user pans using the navigational controls 220, the user interface controller 214 may determine a rectangular GIS boundary according to the view port 227 of the map 219 dependent on the panned location and zoom setting of the navigational controls 220 and select a main subregion 226 therein, such as a subregion 226 most centrally located within the view port 227 of the map 219.

The map search interface 210 may further comprise a categorisation interface 228 representing search parameter match totals categories of GIS objects within the subregion 226.

FIG. 4 illustrates exemplary processing 229 for generating the map search interface 210 in accordance with an embodiment which will be described in accordance with an exemplary application for searching for off-market real estate properties for which specific locations thereof cannot be displayed or specified.

A plurality of users register with the system 200, thereby creating a plurality of respective user profiles 223.

A first type of user profile may be for seller users which, for example, use client terminal 202A, to list their properties for off-market sale. As such, each user would input specifics in relation to their property (GIS object), including the location and attributes.

The location specified for each GIS object may be any location data suitable for allowing the system 200 to determine which GIS objects fall within respective subregion/suburbs 226.

For example, the location may be specified by GPS coordinates or street number. In less preferred embodiments, the location may be specified by street name.

As such, at step 223, the system receives GIS object location and attribute data of a plurality of GIS objects (in this example, off-market real estate properties for sale).

Continuing the example, potential purchasers wishing to search for off-market properties similarly create user profiles 223, using client terminals 202C for example.

As alluded to above, when creating a user profile, each potential purchaser user may input the GIS object/property search parameters. For example, a potential purchaser user may specify that the user is interested in a three bedroom, one garage house, within 5 km of a primary school for less than $1.8 million.

Alternatively, the user may input such GIS object search parameters using the search parameter input fields 222 of the search parameter interface 221 when searching in real-time. As such, as the user adjusts the data within the fields 222, the interface 210 may update in substantial real-time.

As such, at step 231, the system 200 receives GIS object search parameters.

At step 232, the system 200 receives or determines a geographic subregion 226 within the GIS data 215.

As alluded to above, a user may input a subregion 226 identifier, such as a postcode or suburb name into the subregion search input field 225 of the interface 210. Alternatively, the system may determine the main subregion 226 displayed within the view port 227 of the map 219 as the user navigates using the navigational controls 220.

In embodiments, the system 200 may display a boundary demarcation overlay 237 around the selected or active subregion 226.

At step 233, the system 200 determines a subset of GIS objects from the plurality of GIS objects falling within the geographic subregion 226 according to the provided location data of the plurality of GIS objects. In this example, the system 200 may select the properties falling within the boundary 237 of the subregion 226.

At step 234, the system 200 assigns search parameter match total categories to the subset of selected GIS objects according to the total number of attributes of each GIS object/property matching search parameters.

For example, for a property comprising three bedrooms and costing $1.6 million and being 2.4 km from a primary school, 0 would be assigned to a search parameter searching for four bedrooms, 1 would be assigned to a search parameter searching for properties less than $1.8 million and 1 would be assigned to a search parameter searching for properties less than 5 km from a primary school, thereby generating a search parameter match total of 2. As such, the GIS object/property would be assigned to the “2” search parameter match total category.

Further for example, for five search parameter input fields 222, each GIS object/property 215 within the subregion 226 could be assigned to a category ranging from zero (no search parameter matches) to 5 (all parameters matching).

At step 235, the system 200 generates the map search interface 210 comprising the map 219 rendered from the GIS data 215.

At step 236, the user interface controller 214 displays the geographic region (which, as alluded to above, may be a boundary demarcation overlay 237 rendered within the map 219 but, in embodiments, may be displayed adjacent the map 219 including in word form) along with the categorisation interface 228 which displays search parameter match total categories 238 for the subset of GIS objects/properties 215 within the geographic subregion 226.

In the embodiment shown in FIG. 3, each category 238 may display a numeric total 239 along with a description 240. Additionally, or alternatively, each category 238 may be displayed according to a colour scale or colour shade wherein, for example, green indicates all search parameters matching and red indicates no parameters matching with colours or shades in between.

In alternative embodiments, shapes may be used to display the categories 238.

In embodiments, the user may click on a particular category 238 to view a listing of GIS objects/properties therein.

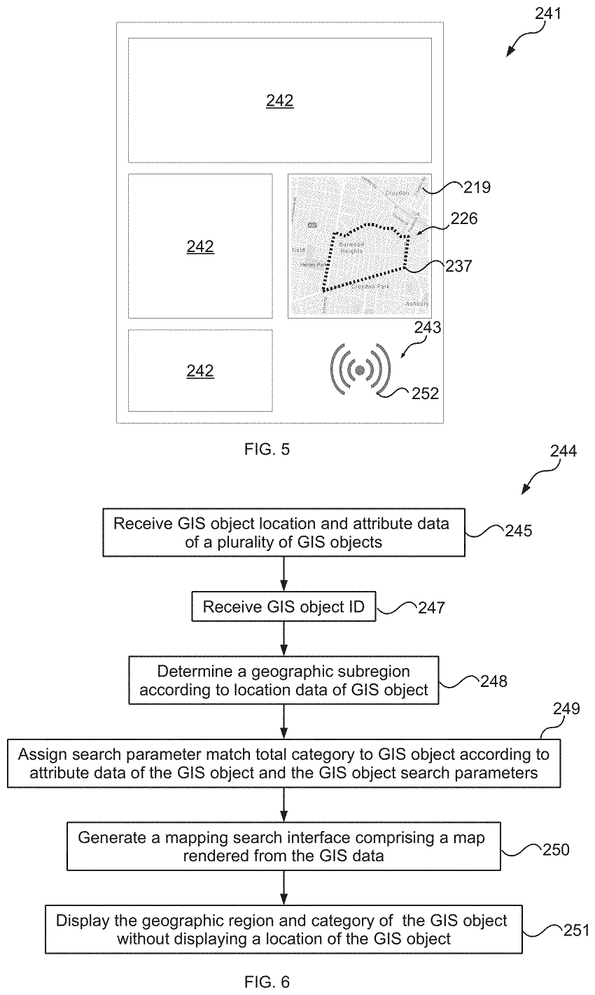

FIG. 5 shows an exemplary GIS object information interface 241 which, according to the present example may be an off-market property listing information page. The user may click through to the information interface 214 via the aforedescribed listing of GIS objects/properties of each category 238. The interface 241 may comprise a number of information regions 242 including text and image data.

The interface 241 may further comprise a map 219. The interface 241 may further display the subregion 226 which may be displayed as a boundary overlay 237 displayed on the map 219 or alternatively adjacently displayed information, including in word format.

The interface 241 may further comprise a visual match indicator 243.

FIG. 6 shows exemplary processing 244 by the system 200 for displaying the GIS object information interface 241.

The processing 244 may similarly comprise receiving the GIS object location and attribute data of a plurality of GIS objects at step 245.

At step 247, the system 200 may receive a GIS object ID which, in this example, may be a property ID.

At step 248, the system 200 determines the geographic subregion 226 using the GIS data 215 and the location data of the GIS object. In this example, the geographic subregion 226 may be the suburb within which the identified property is located.

At step 249, the system 200 assigns a search parameter match category to the GIS object according to attribute data from the GIS object and the GIS object search parameters. As alluded to above, the GIS object search parameters may be stored in relation to a user profile or alternatively derived from the search parameter input fields 222 displayed in a previous screen.

At step 250, the system generates the interface 241 comprising the map 219 rendered from the GIS data.

At step 251, the system displays the geographic region 226 and the category of the GIS object according to the GIS object search parameters without displaying the specific location of the GIS object.

In the embodiment shown, the geographic subregion is displayed as the boundary 237 demarcation overlay 237.

The boundary demarcation overlay 237 may be displayed in a colour or shade according to the calculated search parameter match category.

For example, where the GIS object/property meets all of the users search parameters, the boundary demarcation overlay 237 may be displayed green whereas, should none be matched, the boundary demarcation 237 may be displayed red.

Additionally, or alternatively, the search parameter match total category may be displayed using the visual indicator 243. The visual indicator 243 may comprise a plurality of layers 252. Should all of the search parameter match, all of the layers 252 may be highlighted whereas, if none of the search parameters match, none of the layers 252 may be highlighted whereas should only a partial number of search parameters match, the layers 252 may be correspondingly partially highlighted, either from the outside in or from the inside out.

As such, in this example, using the visual indicator 243, the user is able to quickly visually ascertain the suitability of the property according to the users search parameters.

FIG. 8 illustrates an exemplary profile information interface 253 which, in this example, may display information in relation to a real estate agent profile of a real estate agent who, for example, uses client terminals 202B. The interface 253 may comprise various information regions 242 in relation to the profile including in text and image data format.

FIG. 9 shows exemplary processing 254 for generating the interface 253 which will be described with reference to present off-market property listing example.

At step 255, the system 200 may similarly receive GIS object location and attribute data of a plurality of GIS objects which, in this example, represent a plurality of off-market listings.

At step 256, the system 200 may receive GIS object attributes which, in this example, represent the attributes of a property of a potential seller.

At step 257, the system 200 receives profile relationships which, in this case, represents relations between profiles relating to prospective purchaser and agent profiles. Specifically, using the map search interface 210, the user may click on a particular category 238 to display GIS object/property information interfaces 241 for the GIS objects/properties of the selected category 238.

Then, for a particular GIS object/property, the user may use the interface 241 to make contact with an agent associated with the GIS object/property. As such, the system 200 may update the profiles 223 to relate the profile of the agent and the profile of the interested prospective purchaser.

At step 258, the system 200 receives a profile ID which, in this example, is an agent profile ID such that information of the agent can be displayed using the interface 253.

At step 259, the system 200 determines a subset of GIS objects of the plurality of GIS objects according to the profile relationships. In this example, the system 200 selects the GIS objects/properties associated with the agent.

At step 260, the system 200 assigns GIS object attribute match total categories to the subset of GIS objects according to the GIS object attributes in the profile relationships. In this example, the system 200 determines which GIS objects/properties associated with the agent profile similar to the attributes of the GIS object of the prospective seller.

At step 261, the system 200 displays categories 262 using the interface which may display the number of seller profiles of each category.

For example, the interface 253 may represent that an identified agent has 22 prospective purchasers who are looking for properties matching all four of the attributes of the potential seller's property, 16 prospective purchasers who are looking for properties matching three of the attributes, 10 prospective purchasers who are looking for properties matching two of the attributes and six prospective purchasers who are looking for properties matching none of the attributes.

Similarly, the categories 262 may display the numeric total, or colour or shape indication depending on the match total.

In embodiments, the system 200 may be configured for generating a map search interface 210 wherein the categories 238 displayed represent an aggregation of GIS objects.

For example, in accordance with the present example, a plurality of potential sellers may combine their respective properties together such that the categorisation 238 may further represent the combined size thereof in addition to the search parameter match total category. In this way, a property developer may search for combined properties potentially available for combined development wherein the categories 238 display not only the search parameter match total category but also the size aggregation of the combined GIS objects/properties, such as for example, providing categorisation label comprising “large”, “medium”, and “small”. In alternative embodiments, the aggregation may represent strata entitlement as opposed to surface area.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A map search interface system comprising computer program code instructions controllers configured to:
receive, in relation to user profiles of a first type, GIS object location and attribute data of a plurality of GIS objects;
receive, in relation to a user profile of a second type, GIS object search parameters;
at least one of receive and determine a geographic subregion within GIS data; determine a subset of GIS objects of the plurality of GIS objects falling within the geographic subregion according to location data thereof and the geographic subregion;
assign search parameter match total categories to each of the subset of GIS objects according to attribute data of the subset of GIS objects and the GIS object search parameters; and
generate a map search interface comprising a map rendered from the GIS data, the map search interface displaying the geographic subregion and the search parameter match total categories of the subset of GIS objects, without displaying a specific location of each respective GIS object.

2. The system as claimed in claim 1, wherein the geographic subregion is selected from subregions specified by the GIS data.

3. The system as claimed in claim 1, wherein the geographic region is displayed as a boundary demarcation overlay on the map.

4. The system as claimed in claim 3, wherein at least one of receiving and determining a geographic subregion within the GIS data comprises receiving, via the map search interface, a geographic region identifier and looking up the geographic region boundary data from the GIS data.

5. The system as claimed in claim 1, wherein the map is an interactive map and wherein at least one of receiving and determining the geographic subregion within the GIS data comprises determining the geographic subregion in accordance with a view port of the map.

6. The system as claimed in claim 5, wherein the geographic subregion is selected as a most central geographic subregion within the viewport.

7. The system as claimed in claim 1, wherein the map search interface displays each search parameter match total category as a numeric value.

8. The system as claimed in claim 1, wherein the map search interface displays each search parameter match total category as at least one of a different colour and a different shade of a colour.

9. The system as claimed in claim 1, wherein the map search interface comprises a plurality of search parameter input fields and wherein the search parameter match total categories are displayed dynamically responsive to data input via the search parameter input fields.

10. The system as claimed in claim 1, further comprising receiving a selection of a category via the map search interface and displaying an informational interface listing of the GIS objects within the category without displaying a specific locations thereof.

11. The system as claimed in claim 1, further comprising receiving a GIS object ID of a GIS object wherein the computer program code instruction controllers are further configured to:
determine a geographic subregion according to location data of the GIS object; assign a search parameter match total category to the GIS object according to attributes of the GIS object and the GIS object search parameters; and
generating a GIS object informational interface comprising a map rendered from the GIS data and displaying the geographic subregion and the search parameter match total category.

12. The system as claimed in claim 11, wherein the geographic subregion is generated as a boundary demarcation overlay on the map.

13. The system as claimed in claim 11, wherein the boundary demarcation overlay is displayed in at least one of a colour and a shade of colour according to the search parameter match total category.

14. The system as claimed in claim 11, wherein the search parameter match total category is displayed using a visual indicator wherein elements thereof are highlighted according to the search parameter match total category.

15. The system as claimed in claim 11, wherein the visual indicator comprises a plurality of concentric layers and wherein subsets thereof are displayed at least one of from outside in an inside out depending on the search parameter match total category.
